(19) United States
(12) Patent Application Publication
(10) Pub. No.: US 2024/0321538 A1
(43) Pub. Date: Sep. 26, 2024

(54) CASING FOR A TEMPERATURE-DEPENDENT SWITCH AND SEALED SWITCHING DEVICE

(71) Applicant: Marcel P. Hofsaess, Steintahleben (DE)

(72) Inventor: Marcel P. Hofsaess, Steintahleben (DE)

(21) Appl. No.: 18/613,771

(22) Filed: Mar. 22, 2024

(30) Foreign Application Priority Data
Mar. 23, 2023 (DE) 10 2023 107 383.4

(51) Int. Cl. H01H 37/54

(52) U.S. Cl. CPC H01H 37/5427

(57) ABSTRACT

A casing for a temperature-dependent switch that switches in a temperature-dependent manner between a closed state, in which the switch establishes an electrically conductive connection between first and second external terminals, and an open state, in which the switch disconnects the electrically conductive connection. The casing comprises: a first casing part made of metal; a second casing part made of metal connected to the first casing part via a hermetically sealing, material-locking connection comprising an electrically insulating connection material; a receptacle for receiving the temperature-dependent switch, wherein the receptacle is at least partially surrounded by the first and second casing parts; a first connection lead led through the electrically insulating connection material for electrical connection to the first external terminal; and a second connection lead led through the electrically insulating connection material for electrical connection to the second external terminal.

### CROSS-REFERENCE TO RELATED APPLICATIONS

This application claims priority from German patent application DE 10 2023 107 383.4 filed on Mar. 23, 2023. The entire content of this priority application is incorporated herein by reference.

### FIELD

This disclosure relates to a casing for hermetically sealing a temperature-dependent switch. This disclosure further relates to a sealed switching device comprising the casing and a temperature-dependent switch arranged therein.

### BACKGROUND

An exemplary temperature-dependent switch is disclosed in DE 37 33 693 A1. This document also discloses a casing for receiving the temperature-dependent switch in a hermetically sealed manner.

Such temperature-dependent switches are used in a principally known manner to monitor the temperature of a device. For this purpose, the switch is brought into direct or indirect thermal contact with the device to be protected, so that the temperature of the device to be protected influences the temperature of the switching mechanism arranged inside the switch.

The switch is typically connected electrically in series into the supply circuit of the device to be protected via connecting cables, so that the supply current of the device to be protected flows through the switch below the response temperature of the switching mechanism.

Such temperature-dependent switches comprise a temperature-dependent switching mechanism which is arranged encapsulated in a switch housing and which, depending on its temperature, opens or closes an electrically conductive connection between the two external terminals of the switch. More precisely, the temperature-dependent switching mechanism is configured to switch in a temperature-dependent manner between a closed state, which the switching mechanism assumes below a response temperature and in which the switching mechanism establishes the electrically conductive connection between the two external terminals, and an open state, which the switching mechanism assumes above the response temperature and in which the switching mechanism disconnects the electrically conductive connection.

To enable the above-mentioned temperature-dependent switching function, the temperature-dependent switching mechanism arranged inside the switch housing usually comprises a bimetal part which deforms abruptly from its low-temperature state to its high-temperature state when the response temperature is reached and thereby lifts off a movable contact part, which is arranged on a device movable relative to the switch housing, from a stationary contact. The stationary contact is typically arranged in a fixed position inside the switch housing and is electrically connected to one of the two external terminals of the switch, while the moving contact part interacts either via the bimetal part or a spring part associated with the bimetal part.

In a temperature-dependent switch, as disclosed for example in DE 198 27 113 A1, the bimetal part is provided as a bimetal disc which is coupled with a current transmission element which, in the closed state of the switching mechanism, electrically connects the two stationary contacts arranged on the cover part of the switch housing with each other and, in the open state of the switching mechanism, lifts off the current transmission element from the two stationary contacts to disconnect the electrically conductive connection between them.

For certain applications, such switches must be equipped with special encapsulations, which usually have to be provided in addition to the conventional switch housing of the switch. This is necessary, for example, if such temperature-dependent switches are applied in corrosive or explosive environments. The same applies if temperature-dependent switches are inserted in environments in which the switches are exposed to comparatively high external pressures.

In the aforementioned applications, it can be required for safety reasons that the temperature-dependent switches are hermetically gas-tight or encapsulated in a hermetically gas-tight manner.

In the switch disclosed in DE 37 33 693 A1 mentioned at the beginning, this is solved by inserting the switch into an additional metal housing, which is provided with a separate cover, which is also made of metal and is welded to the metal housing after the switch has been inserted. Pressure glass feedthroughs made of glass are provided in this cover, through which the connecting cables of the switch are routed from the inside to the outside. Before the metal housing is hermetically sealed, but after the switch has been inserted, the metal housing is flushed with inert gas, preferably helium or nitrogen, and filled with this gas if necessary. The connecting cables are typically laser-welded and the pressure glass feedthroughs are fused with the metal housing.

In this way, a hermetically encapsulated temperature switch can be provided that is configured to be extremely pressure-resistant and can be used in corrosive and potentially explosive environments.

However, the method of manufacturing the encapsulated temperature switch disclosed in DE 37 33 693 A1 has various disadvantages. Firstly, the manufacture of the hermetically encapsulated switch described therein requires a high level of manual labor. In addition, the temperature-dependent switch mechanism arranged inside the switch housing can be damaged when closing the metal housing or attaching the pressure glass feedthroughs made of glass. Such glass melts lead to extremely high temperatures during their manufacture. However, common temperature-dependent switching mechanisms that are inserted inside the switch can typically be exposed to a maximum of 200 to 500° C. without causing damage to the bimetal part inserted in them.

### SUMMARY

It is an object to provide an improved casing for receiving, in a hermetically sealed manner, a temperature-dependent switch, which casing is as simple as possible to manufacture, which enables simple and preferably automated handling and which does not require the switch together with its switching mechanism to be exposed to critical (high) temperatures to encapsulate the switch.

According to an aspect, it is provided a casing for a temperature-dependent switch that is configured to switch in a temperature-dependent manner between a closed state, in which the switch establishes an electrically conductive connection between a first external terminal and a second external terminal, and an open state, in which the switch disconnects the electrically conductive connection, wherein the casing comprises:
a first metal casing part;
a second metal casing part which is fixed to the first metal casing part via a hermetically sealing connection comprising an electrically insulating connection material;
a receptacle for receiving, in a hermetically sealed manner, the temperature-dependent switch, wherein the receptacle is at least partially surrounded by the first metal casing part and the second metal casing part;
a first connection lead which is led through the electrically insulating connection material and comprises a first connection surface arranged in the receptacle for electrical connection to the first external terminal of the temperature-dependent switch; and
a second connection lead which is led through the electrically insulating connection material and comprises a second connection surface arranged in the receptacle for electrical connection to the second external terminal of the temperature-dependent switch.

The casing has a multi-part structure having first casing part made of metal, a second casing part made of metal, and an electrically insulating connection material which connects the two casing parts to one another in a material-locking and hermetically sealing manner. In contrast to the encapsulated temperature switch disclosed in DE 37 33 693 A1, the two casing parts are not welded together, but are connected to each other by means of the electrically insulating connection material, through which the two connection leads are also led through. The electrically insulating connection material therefore serves not only to lead through the two connection leads and electrically insulate the two connection leads from each other, but also to produce a hermetically sealing connection between the two metal casing parts. This offers various advantages.

One advantage of the casing is that the casing with its two casing parts can be pre-produced in advance, i.e. before the switch is inserted into it, as a semi-finished product. This simplifies the final completion immensely, as the switch only has to be inserted into the prefabricated casing in a final work step and hermetically sealed in it. This final step can include the production of a welded, fused or soldered connection, which can be easily automated.

In particular, it is advantageous that the hermetically sealing, material-locking, electrically insulating connection between the first casing part and the second casing part can be established in advance, i.e. before the switch is inserted. The melting processes typically required for this, which generate very high temperatures, therefore have no effect on the switch itself, as it is only inserted into the casing afterwards. The switching mechanism of the switch is therefore not damaged. This is a significant difference to DE 37 33 693 A1, for example, in which the pressure glass feedthroughs made of heated glass can only be produced after the switch has been inserted into the metal housing.

In the herein presented device, however, this melting process can already be performed in advance, since the two connection leads are led through the same electrically insulating connection material from the inside to the outside, which also connects the two casing parts to each other in a materially-locking manner. Each of these two pre-integrated connection leads terminates at a first end in a connection surface arranged in the receptacle (referred to as the first and second connection surfaces in the present case), which connection surface is used for the electrical connection to the two external terminals of the temperature-dependent switch.

The receptacle preferably comprises a recess into which the temperature-dependent switch can be inserted. The two connection surfaces are arranged in this recess in such a way that the temperature-dependent switch automatically comes to rest with its two external terminals on the two connection surfaces when it is inserted into the recess/receptacle. This makes the electrical connection of the switch, despite the insertion of the switch into the casing, very simple, preferably automated, and cost-effective.

The two connection leads integrated into the casing, which are led through the electrically insulating connection material, preferably each comprise a second end which is arranged outside the receptacle, i.e. is led to the outside. Corresponding lines can be connected very easily to this respective second end of the two connection leads in order to be able to connect the casing and thus also the temperature-dependent switch arranged therein with the device to be protected in a corresponding manner.

In a refinement, the electrically insulating connection material comprises glass. According to this refinement, the hermetically sealing, material-locking, electrically insulating connection between the first casing part and the second casing part thus comprises a glass-to-metal seal.

Such a glass-to-metal seal enables an electrically insulating connection between the two casing parts on the one hand and a hermetically sealing connection between these two casing parts on the other.

Such glass-to-metal seals enable hermetically sealed connections that meet the requirements of DIN EN 60079-15. According to this, a hermetically sealed connection or a hermetically sealed device is understood to mean a connection/device that is constructed in such a way that it cannot be opened and that is so effectively sealed by fusing that the ingress of external atmosphere is prevented. Preferably, such a hermetically sealed connection enables a vacuum-tight connection between the first and second casing parts.

The term “hermetic” or “hermetically sealed” herein refers to a hermetic connection or a hermetic seal that prevents the exchange of substances from the inside to the outside and from the outside to the inside. Typically, such hermetic closures have a leakage rate of less than 1e-7 mbar. I/s determined by means of a helium leak detector. Achieving such a hermetically sealed device/connection in accordance with DIN EN 60079-15 is generally only possible by fusing metal to metal or glass to metal.

In a preferred refinement, the glass-to-metal connection between the first casing part and the second casing part therefore comprises glass which is fused to the first casing part and the second casing part. This fused connection is preferably a fused connection that extends along a closed contour, for example an annular contour. Hence, a hermetically sealed space can be created inside the casing.

In a further refinement, the casing further comprises a third casing part made of electrically insulating material which is arranged between the first casing part and the first connection lead.

Preferably, this third casing part is also arranged between the first casing part and the second connection lead. It provides electrical insulation between the two connection leads and the first casing part, which is also electrically conductive due to its metal nature.

Preferably, this third casing part is made of ceramic.

The third casing part is particularly preferably inserted into the first casing part.

In a further refinement, the casing further comprises a fourth casing part made of an electrically insulating material which is arranged between the second casing part and the first connection lead.

This fourth casing part is preferably also arranged between the second casing part and the second connection lead. It preferably serves to electrically insulate the second casing part from the two connection leads. Particularly preferably, this fourth casing part also serves to electrically insulate the two connection leads from electrically conductive parts of the switch housing of a temperature-dependent switch inserted into the receptacle. Similar to the third casing part, the fourth casing part is preferably also made of ceramic.

In a further refinement, it is provided that the electrically insulating connection material connects the first casing part, the second casing part, the third casing part and the fourth casing part to one another.

Preferably, the four casing parts according to this refinement are thus fixed relative to one another by the electrically insulating connection material, which preferably comprises glass. In other words, the connection material used for the material connection of the first and second casing parts also simultaneously fixes the third and fourth casing parts within the casing. Thus, all four casing parts of the casing can be fixed relative to each other in advance, i.e. before the switch is inserted into the receptacle of the casing, by means of the connection material.

In a further refinement, the third casing part contacts a first side of the first connection lead, whereas the fourth casing part contacts a second side of the first connection lead opposite the first side.

According to this refinement, it is also preferred that the third casing part contacts a first side of the second connection lead and the fourth casing part contacts a second side of the second connection lead opposite the first side.

The two casing parts made of electrically insulating material, which are herein referred to as the third and fourth casing parts, thus preferably abut the two connection leads integrated in the casing from opposite sides. These two casing parts thus serve on the one hand to electrically insulate the other metal casing parts (referred to as the first and second casing parts) and to electrically insulate the two connection leads and also as static support components of the casing, which increase the mechanical stability of the casing. A refinement of the third and fourth casing parts made of ceramic is also advantageous for this reason, as ceramic is an ideal electrical insulator and also a mechanically high-strength material.

In a further refinement, the first casing part at least partially surrounds the second casing part. Particularly preferably, the first casing part at least partially surrounds the second casing part, the third casing part and the fourth casing part.

The first casing part so to speak forms the outermost shell of the casing. The first casing part is preferably substantially pot-shaped. The second and fourth casing parts are each preferably ring-shaped. The third casing part is preferably substantially plate-shaped and inserted into the first casing part.

An annular configuration of the second casing part and/or the fourth casing part can enable a space-saving arrangement of the casing. “Annular” in the present sense does not necessarily mean circular, but can also be an oval, angular or prismatic closed contour.

In a further refinement, the two connection surfaces lie in a common connection plane.

The casing is therefore suitable in particular for receiving and hermetically sealing temperature-dependent switches whose external terminals are in one plane. According to this refinement, such switches can be electrically connected to the two connection leads of the casing very easily by arranging them with their two external terminals in the connection plane.

As already mentioned at the beginning, this disclosure relates not only to the casing itself (without a temperature-dependent switch inserted therein), but also to the casing having a temperature-dependent switch arranged therein. The casing including the switch inserted therein are herein denoted as “sealed switching device”.

According to an aspect, a sealed switching device is provided, comprising:
a casing; and
a temperature-dependent switch that is configured to switch in a temperature-dependent manner between a closed state, in which the switch establishes an electrically conductive connection between a first external terminal and a second external terminal, and an open state, in which the switch disconnects the electrically conductive connection;
the casing having:
a first metal casing part;
a second metal casing part fixed to the first metal casing part via a hermetically sealing connection comprising an electrically insulating connection material;
a receptacle which is at least partially surrounded by the first metal casing part and the second metal casing part;
a first connection lead which is led through the electrically insulating connection material and comprises a first connection surface arranged in the receptacle; and
a second connection lead which is led through the electrically insulating connection material and comprises a second connection surface arranged in the receptacle;
wherein the temperature-dependent switch is fixed in the receptacle of the casing in a hermetically sealed manner, wherein the first external terminal of the temperature-dependent switch is electrically connected to the first connection surface, and wherein the second external terminal of the temperature-dependent switch is electrically connected to the second connection surface.

In a refinement, the temperature-dependent switch includes a temperature-dependent switching mechanism and a switch housing in which the switching mechanism is arranged, wherein the first external terminal and the second external terminal are arranged on the switch housing.

The switch housing preferably comprises a lower part made of electrically conductive material and a cover part made of an electrically insulating material which closes the lower part the lower part, wherein the first external terminal and the second external terminal are arranged on the cover part.

In a further refinement, it is provided that the casing comprises a fourth casing part made of an electrically insulating material, wherein the fourth casing part is arranged annularly around the switch housing and electrically insulates the first connection lead from the lower part.

Preferably, the fourth casing part ensures that the switch housing is centered by resting against the circumference of the lower part of the switch housing.

In a further refinement, the switch housing is connected to the second casing part in a material-locking manner.

This material-locking connection is preferably also carried out as a hermetically sealing connection, which comprises a metal fusion and is produced, for example, by welding or soldering. As this material-locking connection is made directly on the switch housing, however, it can only be made after the switch has been inserted into the casing. Accordingly, it is important to ensure that as little heat as possible is generated thereby in order to prevent damage to the switching mechanism arranged inside the switch housing.

In an alternative refinement, the casing can further comprise a fifth casing part made of metal, which closes the second casing part at least on one side and is fixed to the second casing part in a material-locking manner.

This material-locking connection is also preferably configured as a hermetically sealing connection in the above-mentioned sense. Compared to the above-mentioned direct material-locking connection of the switch housing with the second casing part, this refinement has the advantage that no direct material-locking connection is made to the switch housing itself. This in turn has a particularly gentle effect on the switching mechanism arranged inside the switch housing.

It is to be understood that the features mentioned above and those to be explained below can be used not only in the combination indicated in each case, but also in other combinations or on their own, without departing from the scope of the present disclosure.

### BRIEF DESCRIPTION OF THE DRAWINGS

FIG. 1 shows a schematic sectional view of an exemplary temperature-dependent switch which can be mounted in the presented casing, wherein the switch is in its low-temperature state;

FIG. 2 shows a schematic sectional view of the switch shown in FIG. 1, wherein the switch is in its high-temperature state;

FIG. 3 shows a schematic sectional view of a first embodiment of the casing without a switch inserted therein;

FIG. 4 shows a schematic sectional view of the casing shown in FIG. 3 with a switch inserted therein; and

FIG. 5 shows a schematic sectional view of a second embodiment of the casing with a switch inserted therein.

### DESCRIPTION OF PREFERRED EMBODIMENTS

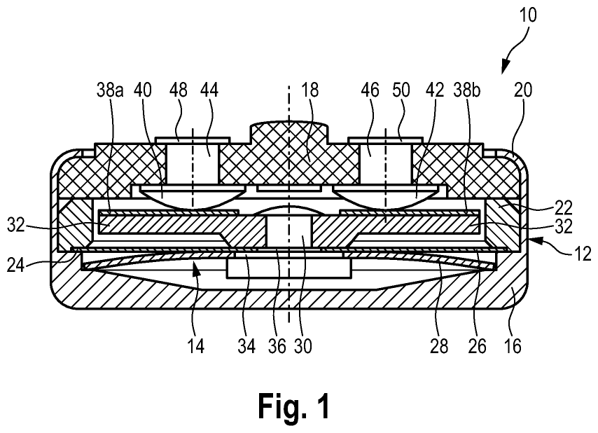

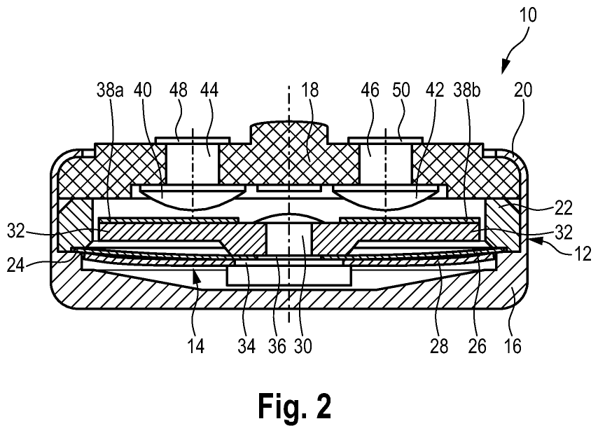

FIGS. 1 and 2 show an exemplary temperature-dependent switch which can be inserted into the casing and can be hermetically sealed by means of the latter. The switch is denoted in its entirety with the reference numeral 10.

FIG. 1 shows the low temperature state of switch 10. FIG. 2 shows the high temperature state of switch 10.

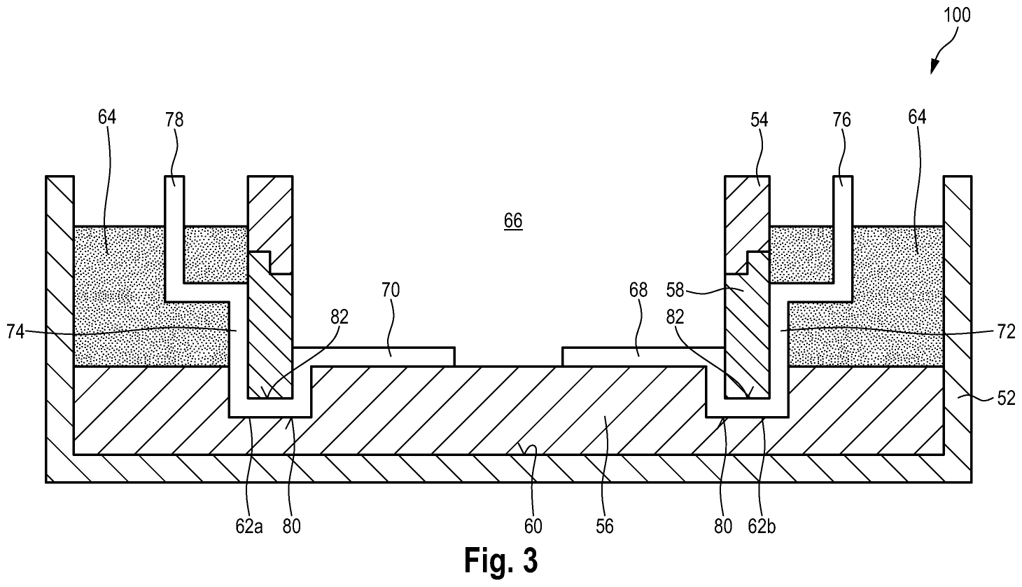

It shall be understood that the switch 10 shown in FIGS. 1 and 2 is only one example of various possible temperature-dependent switches that can be inserted into the casing and can be hermetically sealed in a gas-tight manner by means of this device. As can be seen in particular from FIGS. 3-5, the casing is in principle also suitable for receiving switches with a different configuration. However, the switch 10 shown in FIGS. 1 and 2 is described in the following as an example of a possible temperature-dependent switch in order to explain the basic structure and function of such a temperature-dependent switch.

The switch 10 comprises a switch housing 12, inside which a temperature-dependent switching mechanism 14 is arranged. The switch housing 12 comprises a pot-like lower part 16 and a cover part 18, which is held on the lower part 16 by a bent or flanged upper edge 20 of the lower part 16. In the example of the switch 10 shown in FIGS. 1 and 2, the lower part 16 is made of an electrically conductive material, preferably metal. The cover part 18 is made of an electrically insulating material, for example plastic or ceramic.

A ring 22 is arranged between the lower part 16 and the cover part 18, which ring is supported on a shoulder 24 of the lower part 16. The ring 22 is preferably also made of an electrically insulating material, for example plastic or ceramic.

The switching mechanism 14 comprises a temperature-independent spring disc 26, the outer circumferential edge of which is arranged between the shoulder 24 of the lower part 16 and the ring 22. In addition to the spring disc 26, the switching mechanism 14 comprises a temperature-dependent bimetal part 28, which is configured as a bimetal disc which, together with the spring disc 26, is engaged centrally by a pin-like rivet 30, by means of which the spring disc 26 and the bimetal disc 28 are mechanically connected to a current transmission member in the form of a contact plate 32.

The rivet 30 comprises a first shoulder 34 on which the bimetal disc 28 sits with its inner edge. The inner edge of the bimetal disc 28 preferably sits on this first shoulder 34 of the rivet 30 with radial and axial play. The rivet further comprises a second shoulder 36 on which the spring disc 26 is seated, preferably also with radial and axial play.

On its top side facing the cover part 18, the current transmission member 32 comprises two interconnected contact surfaces 38a, 38b which interact with stationary contacts 40, 42 which are inner heads of rivets 44, 46 which engage through the cover part 18 and with their outer heads form outer terminals 48, 50 of the switch 10.

In the closed state of the switch 10 shown in FIG. 1, the spring disc 26 and the bimetal disc 28 press the current transmission member 32 with its two contact surfaces 38a, 38b against the stationary contacts 40, 42. In this switching state of the switch 10, the switching mechanism 14 thus establishes an electrically conductive connection between the first external terminal 48 and the second external terminal 50.

If, starting from the closed state of the switch 10 shown in FIG. 1, the temperature of the switch 10 and thereby the temperature of the bimetal disc 28 now increases, the latter snaps from its convex position shown in FIG. 1 into its concave position shown in FIG. 2 and thereby rests with its outer, circumferential edge on the bottom side 26 of the spring disc or in the area of the shoulder 24 of the lower part 16 and thereby pulls the current transmission member 32 downwards with its center against the force of the spring disc 26. This lifts off the contact surfaces 38a, 38b of the current transmission member 32 from the two stationary contacts 40, 42 and opens the switch 10. In the open state of the switch 10 shown in FIG. 2, the electrically conductive connection between the two external terminals 48, 50 of the switch 10 is thus disconnected.

The temperature-dependent switching mechanism 14 of the switch 10 is thus configured to establish and disconnect the electrically conductive connection between the two external terminals 48, 50 in a temperature-dependent manner. Below the response temperature of the bimetal disc 28, the switching mechanism 14 is in its low-temperature state shown in FIG. 1, in which it establishes the electrically conductive connection between the two external terminals 48, 50. As soon as the response temperature of the bimetal disc 28 is exceeded, the bimetal disc 28 brings the switching mechanism 14 into the high-temperature state shown in FIG. 2, in which the electrically conductive connection between the two external terminals 48, 50 is interrupted. A subsequent renewed cooling of the bimetal disc 26 below its response temperature brings the switch mechanism 14 again into its low-temperature state shown in FIG. 1, in which the switch 10 is closed again.

FIG. 3 shows a first embodiment of the casing in a schematic sectional view without the switch inserted therein. The casing is denoted in its entirety with the reference numeral 100.

The casing 100 serves to receive a switch 10 and acts as a kind of enclosure which additionally surrounds the switch housing 12 of the switch 10. The casing 100 including the switch 10 inserted therein are herein denoted as “sealed switching device”. The casing 100 comprises a substantially pot-shaped first casing part 52. A second casing part 54, a third casing part 56 and a fourth casing part 58 are arranged in this first casing part 52. The first casing part 52 and the second casing part 54 are preferably made of metal. The third casing part 56 and the fourth casing part 58 are made of an electrically insulating material, preferably ceramic.

The third casing part 56 and the fourth casing part 58 are used for electrical insulation.

The two casing parts 54, 58 are essentially ring-shaped. They therefore form a circumferentially closed contour. The two casing parts 54, 56 are each configured as a type of profiled ring. The second casing part 54 is carried by the fourth casing part 58 and is preferably arranged directly on the latter. The third casing part 56 rests on the inner base 60 of the first casing part 52. The outer diameter of the third casing part 56 corresponds approximately to the inner diameter of the first casing part 52, so that the third casing part 56 is preferably inserted into the first casing part 52 with a precise fit. The top side of the third casing part 56 is provided with a profile comprising at least two recesses 62a, 62b.

The two metallic casing parts 52, 54 are connected to each other by means of a gas-tight, electrically insulating connection material 64. This connection material 64 preferably comprises glass, which provides a hermetically sealing, material-locking, electrically insulating connection between the two casing parts 52, 54. This hermetically sealing, material-locking connection is configured as a fusion connection comprising a glass. This fusion connection is a hermetically sealing glass-to-metal seal that fulfills the tightness requirements specified in DIN EN 60079-15.

The hermetically sealing connection between the two casing parts 52, 54 is preferably produced by means of laser welding. The hermetically sealing connection extends along a closed, annular contour and thus hermetically seals the space between the two casing parts 52, 54 along the entire circumference. At the same time, the third casing part 56 and the fourth casing part 58 are also connected to the two metallic casing parts 52, 54 by means of this glass connection. The four casing parts 52, 54, 56, 58 of the casing 100 thus form an inseparably connected unit.

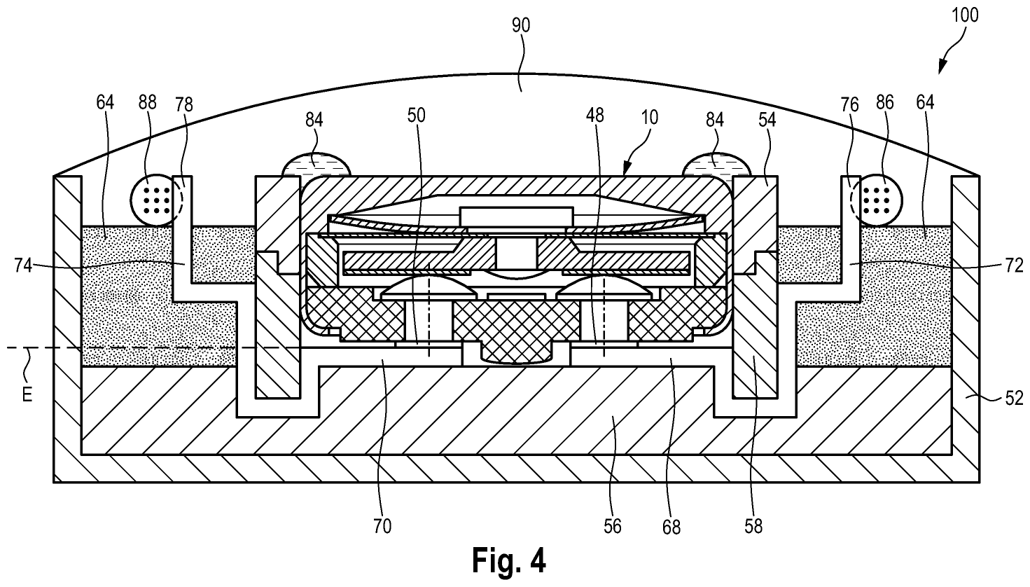

Inside the casing 100, the casing parts 52, 54, 56, 58 together form a recess forming a cavity which is suitable as a receptacle 66 for a temperature-dependent switch 10 to be inserted therein. Two connection surfaces 68, 70 are provided in this receptacle 66, which serve for the electrical connection of the switch 10. In the inserted state of the switch 10, the two connection surfaces 68, 70 are in contact with the two external terminals 48, 50. The first connection surface 68 is in contact with the first external terminal 48 of the switch 10. The second connection surface 70 is in contact with the second external terminal 50 of the switch 10. In the inserted state, the switch 10 is thus so to speak inserted “upside down” into the receptacle 66 (see FIG. 4). To improve the electrical contacting and to fix the switch 10 in place, the two connection surfaces 68, 70 are preferably connected to the respective external terminal 48, 50 in a material-locking manner (e.g. by soldering or welding).

The two connection surfaces 68, 70 arranged in the receptacle 66 are electrically connected to a respective external terminal 76, 78 of the casing 100 via a respective connection lead 72, 74. The two connection leads 72, 74 extend through the electrically insulating connection material (glass) 64, which connects the two metallic casing parts 52, 54 to each other in a material-locking manner. In other words, the two connection leads 72, 74 are routed to the outside with this connection material 64.

Each of the two connection leads 72, 74 is arranged in a section adjacent to the respective connection surface 68, 70 between the two electrically insulating casing parts 56, 58. The third casing part 52 contacts a respective bottom side of the connection leads 72, 74. The fourth casing part 58 contacts the two connection leads 72, 74 from an opposite upper side 82.

It is understood, however, that the two casing parts 56, 58 made of electrically insulating material are not necessarily required for the structure of the casing 100. In particular, these two casing parts 56, 58 can be dispensed with if the two connection leads 72, 74 are sheathed with an electrically insulating material. However, the provision of the two casing parts 56, 58 has the advantage of increasing the mechanical stability of the casing 100. In particular, the passage of the two connection leads 72, 74 through the recesses 62a, 62b provided in the third casing part 56, in which the fourth casing part 58 is also arranged, makes a positive contribution to stabilizing the casing 100. Since the fourth casing part 58 is preferably an annular component, the two recesses 62a, 62b are preferably connected to each other. The two recesses 62a, 62b are thus preferably annular in shape. However, it is understood that the two connection leads 72, 74 are not annular in shape and also have no contact with one another.

FIG. 4 shows in a schematic way how the switch 10 can be inserted into the receptacle 66 of the casing 100. The switch 10 is inserted “upside down” into the receptacle 66. This means that the lower part 16 of the switch 10 points upwardly, while the cover part 18 of the switch 10 points downwardly and faces the bottom of the receptacle 66.

When inserted into the receptacle 66, the switch 10 rests with its first external terminal 48 against the first connection surface 68 and with its second external terminal 50 against the second connection surface 70. As already mentioned, the two external terminals 48, 50 are preferably fixed to the respective connection surface 68, 70 in a material-locking manner.

In order to hermetically seal the switch 10 in a gas-tight manner by means of the casing 100, the switch 10 is fused with its lower part 16, which is preferably made of metal, to the second casing part 54 after it has been inserted into the receptacle 66. According to the embodiment shown in FIG. 4, this is carried out by means of a fusion joint 84 created by welding or soldering, which connects the lower part 16 of the switch 10 to the second casing part 54 along a closed, circumferential contour in a material-locking manner. This material-locking connection between the metallic second casing part 54 and the metallic lower part 16 of the switch 10 also creates a hermetically gas-tight connection at this point. Thus, all points through which an exchange of atmosphere could take place between the interior of the switch and the external atmosphere surrounding the casing 100 are hermetically sealed in a gas-tight manner.

The second casing part 54 is directly fused to the switch 10 and the two metallic casing parts 52, 54 are hermetically connected to each other in a gas-tight manner with the aid of the connection material 64. Thus, neither atmosphere can escape from the interior of the switch 10 nor can atmosphere penetrate into the interior of the switch 10 from the outside. Since the two connection leads 72, 74 are led to the outside by the connection material 64, the switch 10 can be electrically connected to a device to be protected in a simple way even after it has been inserted into the casing 100. For this purpose, only corresponding connection lines 86, 88 must be connected to the two external terminals 76, 78 of the casing 100.

For additional sealing and mechanical stabilization, the switch 10 fixed in the casing 100 can additionally be covered with a resin cover 90.

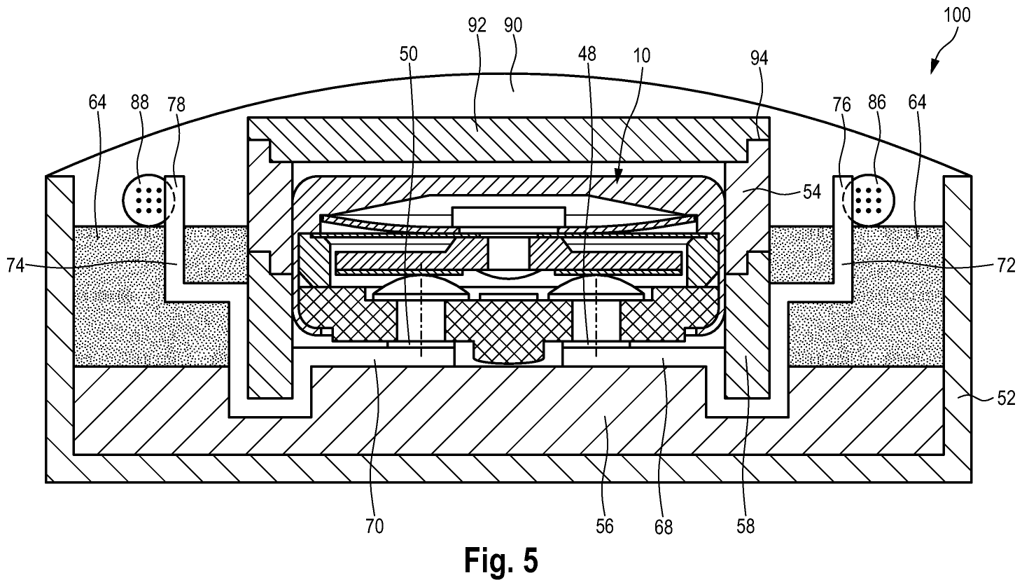

FIG. 5 shows a second embodiment of the casing 100. The basic structure of the casing 100 does not differ from the first embodiment shown in FIG. 4. However, here the second casing part 54 is no longer directly connected to the lower part 16 of the switch 10 in the inserted state of the switch 10.

In the second embodiment shown in FIG. 5, the casing 100 further comprises a fifth casing part 92 which functions as a kind of cover part for closing the second casing part 54. The fifth casing part 92 is also made of metal. It closes the second casing part 54 on its top side and is connected to the second casing part 54 by a material bond. A fusion joint 94, which is preferably configured as a circumferential welded joint, is provided for this purpose. Thus, in this embodiment, the interior of the casing 100, which serves as receptacle 66 for the switch 10, is also hermetically sealed.

In this case also, a resin cap 90 can provide additional sealing.

Both herein shown embodiments of the casing 100 thus ensure a hermetically sealing or encapsulation of the switch 10, by which the switching mechanism 14 arranged in the interior of the switch housing 12 is enclosed in a gas-tight manner towards the outside. The interfaces between the individual casing parts 52, 54 and 54, 92 and the interface between the second casing part 54 and the switch lower part 16 are each realized as standard by hermetically sealed fusion connections, which are designed either as metal-to-metal fusion connections or as glass-to-metal connections. Despite the hermetic seal within the casing 100, the switch 10 can still be connected electrically in a simple way.

Due to the modular configuration of the casing 100, it is suitable for the hermetic encapsulation of temperature-dependent switches of various configurations. However, the casing 100 is preferably used for encapsulating switches whose external terminals 48, 50 lie in a common connection plane E.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A casing for a temperature-dependent switch that is configured to switch in a temperature-dependent manner between a closed state, in which the switch establishes an electrically conductive connection between a first external terminal and a second external terminal, and an open state, in which the switch disconnects the electrically conductive connection, wherein the casing comprises:
a first metal casing part;
a second metal casing part which is fixed to the first metal casing part via a hermetically sealing connection comprising an electrically insulating connection material;
a receptacle for receiving, in a hermetically sealed manner, the temperature-dependent switch, wherein the receptacle is at least partially surrounded by the first metal casing part and the second metal casing part;
a first connection lead which is led through the electrically insulating connection material and comprises a first connection surface arranged in the receptacle for electrical connection to the first external terminal of the temperature-dependent switch; and
a second connection lead which is led through the electrically insulating connection material and comprises a second connection surface arranged in the receptacle for electrical connection to the second external terminal of the temperature-dependent switch.

2. The casing according to claim 1, wherein the electrically insulating connection material comprises glass.

3. The casing according to claim 1, further comprising a third electrically insulating casing part arranged between the first metal casing part and the first connection lead.

4. The casing according to claim 1, further comprising a fourth electrically insulating casing part arranged between the second metal casing part and the first connection lead.

5. The casing according to claim 1, further comprising a third electrically insulating casing part arranged between the first metal casing part and the first connection lead, and a fourth electrically insulating casing part arranged between the second metal casing part and the first connection lead, wherein the electrically insulating connection material connects the first metal casing part, the second metal casing part, the third electrically insulating casing part and the fourth electrically insulating casing part to one another.

6. The casing according to claim 1, further comprising a third electrically insulating casing part arranged between the first metal casing part and the first connection lead, and a fourth electrically insulating casing part arranged between the second metal casing part and the first connection lead, wherein the third electrically insulating casing part contacts a first side of the first connection lead, and wherein the fourth electrically insulating casing part contacts a second side of the first connection lead opposite the first side.

7. The casing according to claim 1, wherein the first metal casing part surrounds the second metal casing part.

8. The casing according to claim 1, wherein the first connection surface and the second connection surface lie in a common connection plane.

9. The casing according to claim 1, wherein the first metal casing part is pot-shaped, and wherein the second metal casing part is ring-shaped.

10. A sealed switching device, comprising:
a casing; and
a temperature-dependent switch that is configured to switch in a temperature-dependent manner between a closed state, in which the switch establishes an electrically conductive connection between a first external terminal and a second external terminal, and an open state, in which the switch disconnects the electrically conductive connection;
the casing having:
a first metal casing part;
a second metal casing part fixed to the first metal casing part via a hermetically sealing connection comprising an electrically insulating connection material;
a receptacle which is at least partially surrounded by the first metal casing part and the second metal casing part;
a first connection lead which is led through the electrically insulating connection material and comprises a first connection surface arranged in the receptacle; and
a second connection lead which is led through the electrically insulating connection material and comprises a second connection surface arranged in the receptacle;
wherein the temperature-dependent switch is fixed in the receptacle of the casing in a hermetically sealed manner, wherein the first external terminal of the temperature-dependent switch is electrically connected to the first connection surface, and wherein the second external terminal of the temperature-dependent switch is electrically connected to the second connection surface.

11. The sealed switching device according to claim 10, wherein the temperature-dependent switch comprises a temperature-dependent switching mechanism and a switch housing, in which the temperature-dependent switching mechanism is arranged, wherein the first external terminal and the second external terminal are arranged on the switch housing.

12. The sealed switching device according to claim 11, wherein the switch housing comprises an electrically conductive lower part and an electrically insulating cover part which closes the electrically conductive lower part, wherein the first external terminal and the second external terminal are arranged at the electrically insulating cover part.

13. The sealed switching device according to claim 12, wherein the casing further comprises a fourth electrically insulating casing part, wherein the fourth electrically insulating casing part is arranged annularly around the switch housing and electrically insulates the first connection lead from the electrically conductive lower part.

14. The sealed switching device according to claim 11, wherein the switch housing is connected to the second metal casing part in a material-locking manner.

15. The sealed switching device according to claim 10, wherein the casing further comprises a fifth metal casing part, which closes the second metal casing part at least on one side and is fixed to the second metal casing part in a material-locking manner.
